(19) United States
(12) Patent Application Publication
(10) Pub. No.: US 2007/0183342 A1
(43) Pub. Date: Aug. 9, 2007

(54) Peer-to-peer broadcast management system

(75) Inventors: Hanson Wong, San Francisco, CA (US); Paul Kelly, Redwood City, CA (US); Chris Westall, San Francisco, CA (US); Graham Golder, Fremont, CA (US); Michelle Wu, Cupertino, CA (US); Wenjie Zhu, Shanghai (CN); Weijun Li, Shanghai (CN); Hao Chen, Shanghai (CN); Dafu Deng, Shanghai (CN)

Correspondence Address: SCHWEGMAN, LUNDBERG, WOESSNER & KLUTH, P.A., P.O. BOX 2938, MINNEAPOLIS, MN, 55402, US

(73) Assignee: MEDIAZONE.COM, INC., SAN CARLOS, CA (US)

(21) Appl. No.: 11/703,344

(22) Filed: Feb. 6, 2007

Related U.S. Application Data
(60) Provisional application No. 60/765,884, filed on Feb. 6, 2006.

(51) Int. Cl. H04J 1/16

(52) U.S. Cl. 370/252; 370/352

(57) ABSTRACT

A peer-to-peer broadcast management system is described. A system may include a peer detector to determine one or more peer computer systems associated with a predetermined locality; a peer list generator to generate a peer list of the determined peer computer systems; a communications module to receive a request for content; and a peer selector to process the request for content utilizing the peer list.

### CROSS-REFERENCE TO RELATED APPLICATIONS

This application claims the benefit of U.S. Provisional Application No. 60/765,884, filed on Feb. 6, 2006, under 35 U.S.C. § 119(e), which is hereby incorporated by reference.

### FIELD

This application relates to a method and system to provide content via a peer-to-peer network.

### BACKGROUND

Traditional media server and media player solutions are based on the client/server model. A client, e.g., a media player acquires media from dedicated streaming servers or download servers. However, as the number of concurrent users (clients) access the streaming server, network bandwidth is quickly consumed. To address this issue, Internet Content Providers use a Content Delivery Network (CDN) or other technologies to distribute network traffic. However, cost for bandwidth via a CDN service increases as larger audiences demand access to media streams. The cost of broadband distribution, to this point, has been the principal factor that has limited the viability of broadband broadcasting.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example embodiment may be implemented;

FIG. 2 is a block diagram of a system to provide content via a peer-to-peer network, in accordance with an example embodiment;

FIG. 3 a flow chart of a method to provide content via a peer-to-peer network, in accordance with an example embodiment;

FIG. 4 is a block diagram illustrating a broadcast distribution system with an advertisement server integrated into a peer to peer environment, in accordance with an example embodiment;

FIG. 5 is a diagrammatic representation of a peer-to-peer streaming platform, in accordance with an example embodiment; and

FIG. 6 is a diagrammatic representation of an example machine in the form of a computer system within which a set of instructions, for causing the machine to perform any one or more of the methodologies discussed herein, may be executed.

### DETAILED DESCRIPTION

In the following description, for purposes of explanation, numerous specific details are set forth in order to provide a thorough understanding of an example embodiment of the present invention. It will be evident, however, to one skilled in the art that the present invention may be practiced without these specific details.

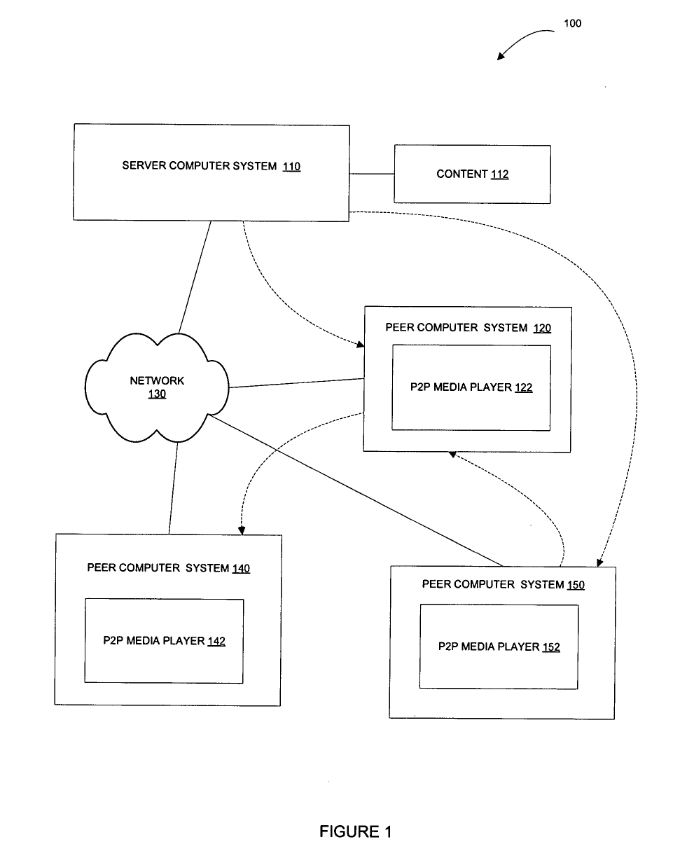

A peer-to-peer broadcast management system, in one example embodiment, utilizes a peer-to-peer streaming platform to provide an efficient way to deliver rich media to an audience via peer-to-peer streaming. A peer-to-peer streaming platform, according to an example embodiment, permits a client application (e.g., user's desktop media player) to share streams from both the bandwidth upstream (e.g., from dedicated streaming servers) and from the bandwidth downstream (e.g., from other peer computer systems within a network. Thus, a peer computer system within the network may act as both a server and a client simultaneously. In some embodiments, such arrangement may reduce network bandwidth requirements for the streaming servers or for the download servers. Furthermore, as more peers join the peer-to-peer streaming network and thus become available for sharing media streams, the quality of provided media stream may improve. An example network environment 100, within which a peer-to-peer broadcast management system may be implemented, is illustrated in FIG. 1.

As shown in FIG. 1, the network environment 100 may include a server system 110 that has access to content 112. The server system 110 may provide content 112 to peer computer systems 120, 140, and 150 via a communications network 130. The communications network 130 may be a public network (e.g., the Internet, a wireless network, etc.) or a private network (e.g., LAN, WAN, Intranet, etc.).

The peer computer systems 120, 140, and 150 may be provided with peer-to-peer (P2P) media players 122, 142, and 152 respectively. A P2P media player, in one example embodiment, may facilitate the streaming of content obtained from a content server, e.g., from the server system 110, as well as the streaming of content obtained from peer computer systems, e.g., the peer computer systems 120, 140, and 150. As shown in FIG. 1, the peer computer system 120 may receive content from the server system 110 and, in turn, provide it to the peer computer system 140. The peer computer system 150 may receive different content from the server system 110 and provide it to the peer computer system 120. The peer computer system 150, therefore, acts as a network client when it obtains content from the server system 110, but acts as a network server when it provides content to another peer computer system.

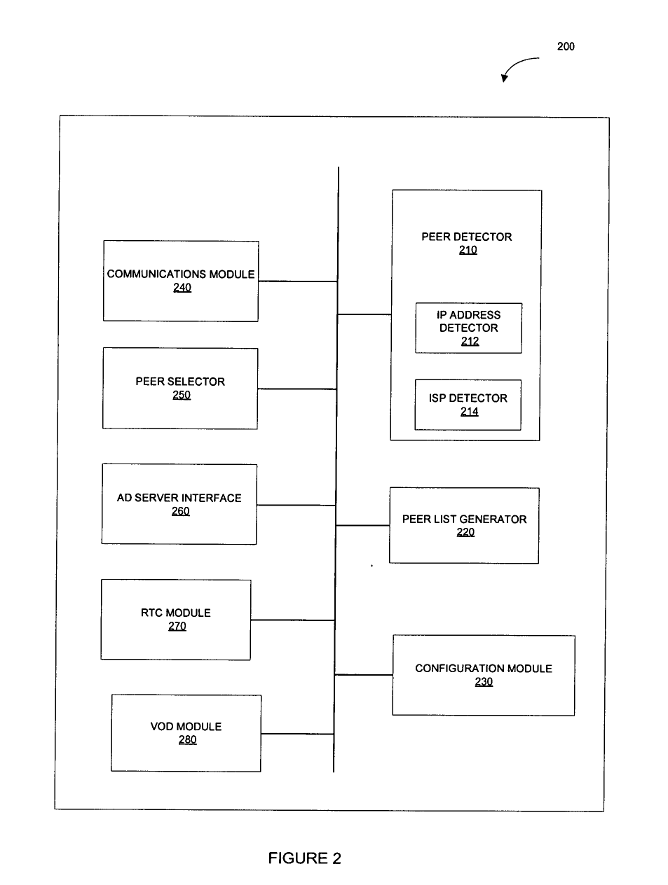

The media players 122, 142, and 152 may be referred to as clients. A client may, in an example embodiment, be a desktop media player application that enables a community of consumers to interact while viewing content protected by Digital Rights Management (DRM) technology, linear channels and downloaded content files served via both centralized servers and peer-to-peer networks. A client may be configured to permit users to view broadcast programs, live events, as well as access video on demand (VOD). Other features of a client may include peer-to-peer streaming and downloading of DRM protected files and real time communications (RTC) features (e.g., chat and watch capability, watch together capability, etc.). A system to provide content via a peer-to-peer network may be incorporated in a client. In some embodiments, a system to provide content via a peer-to-peer network may be separate from a client by may be configured to cooperate with a client in order to provide enhanced viewing experience to consumers. An example system to provide content via a peer-to-peer network may be described with reference to FIG. 2.

FIG. 2 is a block diagram of a system 200 to provide content via a peer-to-peer network, in accordance with an example embodiment. As mentioned above, a peer-to-peer streaming platform may provide an efficient way to deliver media to consumers by permitting peer computer systems within the network to act as both a server and a client.

For example, when a peer computer system acts as a server, the peer computer system (or simply a peer) may serve a media stream (e.g., a media stream that has been provided to the peer computer system by a content server) to other peers within the network, based on locality. Locality may be defined, in one example embodiment, according to an Internet service provider (ISP) associated with the peer computer system, according to an IP address block associated with the peer computer system, according to a zip code associated with a consumer who is in control of the peer computer system, etc.

In one example embodiment, when a peer computer system connects to the peer-to-peer network, the peer computer system initiates a process to find its neighboring peers based on locality criteria. For example, if one peer computer system has the IP address 192.168.100.10, then it may first search for peers within an IP network block of 192.168.100. The peer computer system then further searches for peers with the IP network block of 192.168, if localities or neighboring peers cannot not be found within IP block 192.168.100. When the peer finds all available neighboring peers, it generates a list or a table of peers (a peer list), and maintains the peer list in memory. From the peer list, the peer computer system may identify its neighbors in order to either receive or to serve the streaming content.

As shown in FIG. 2, the system 200 to provide content via a peer-to-peer network, in one example embodiment, includes a peer detector 210 to detect peers that are currently connected to the network and a peer list generator 220 to generate a list of the detected peers. As mentioned above, the peers may be detected by the peer detector 210 based on locality. The peer detector 210 may include one or more locality detectors, such as an IP address detector 212 and an ISP detector 214. A configuration module 230 may be provided with the system 200 to permit an administrator to define locality criteria. In one example embodiment, the peer detector 210, the peer list generator 220, and the configuration module 230 may reside at a server system, e.g., at a download server. The download server may then provide the list to a peer as it connects to the network.

In an example process for downloading of content within a peer-to-peer streaming network, when a peer computer system attempts to access a downloadable media file, it first obtains a list identifying a downloading server and other peer computer systems. The list may include information regarding which downloadable media files are available at which peer computer system. After getting the list, the peer computer system may find local peers by different criteria. Such criteria may include, for example, peers having same IP network block, or same local ISP, or same community based on zip code. After finding all available local peers, the peer computer system may search for a media file that a consumer associated with the peer wishes to download. For example, if a peer computer system has IP address with 192.168.1.66 and the consumer wishes to download the media file for “The Movie”, the peer computer system may access the peer list and determine whether any of the peers in the list may provide “The Movie.”

After finding a peer that may provide “The Movie,” the peer computer system may begin to download well-chunked and sequenced streaming packets encapsulated within the peer-to-peer protocol. The encapsulated peer-to-peer packets are encrypted at the peer-to-peer protocol layer, and are optimized for peer-to-peer streaming network by different networking criteria.

A peer computer system may periodically send query packets to determine availability of other peers for downloading. If a peer disconnects from the network, the peer computer system re-routes to other, new, qualified peers or download servers to acquire the media file continuously. After the peer computer system buffer accumulates enough of the stream, it may start to play the media file while the remaining streaming data is being collected into the buffer. If the peer computer system shuts down its network service due to various reasons, the system 200 may record the breaking point and resume download as it recovers network access.

In one example embodiment, the peer detector 210, the peer list generator 220, and the configuration module 230 may reside at a peer computer system, such that the peers may be detected and the list may be generated locally, at the peer computer system.

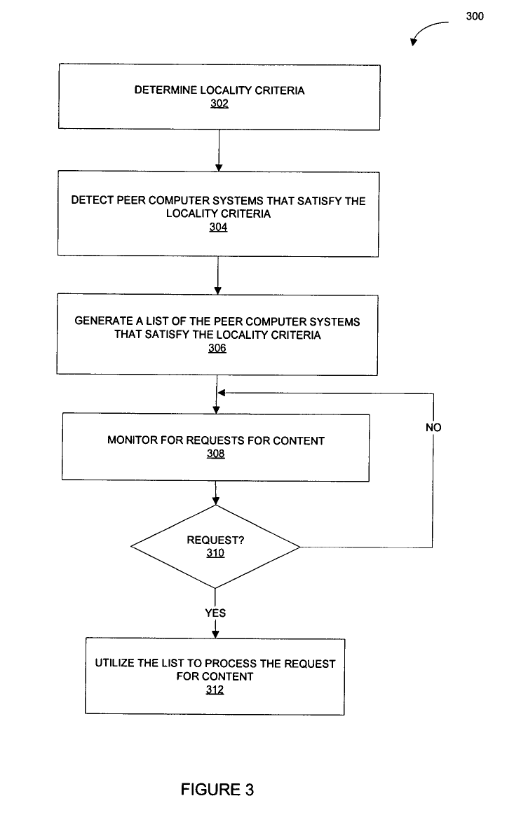

The system 200 to provide content via a peer-to-peer network may include a communications module 240 to receive communications from the operator of an associated computer system, as well as from other network entities, such as network servers and peer computer systems. A message received by the communications module 210 may be a request for streaming content. The system 200 may further include a peer selector 250 to select, from the peer list, a peer that has the requested content. In some example embodiments, the system 200 includes an advertisement server interface 260 to permit integration of an advertisement server into the peer-to-peer streaming platform, an RTC module 270 to permit real time communications among the peers, and a VOD module 280 to permit consumers to download video on demand in the context of the peer-to-peer streaming platform. An example method to provide content via a peer-to-peer network can be described with reference to FIG. 3.

FIG. 3 is a flow chart of a method 300 to provide content via a peer-to-peer network, according to one example embodiment. The method 300 may be performed by processing logic that may comprise hardware (e.g., dedicated logic, programmable logic, microcode, etc.), software (such as run on a general purpose computer system or a dedicated machine), or a combination of both. The method 300 may be performed by the various modules discussed above with reference to FIG. 2. Each of these modules may comprise processing logic.

As shown in FIG. 3, at operation 302, the peer detector 210 determines locality criteria and detects those peer computer systems that satisfy the criteria, at operation 304. If the locality criteria is based on an IP address range, the peer detector 210 may engage the IP address detector 212. If the locality criteria is based on ISP identity, the peer detector 210 may engage the ISP detector 214.

At operation 306, the peer list generator 220 generates a list of peers (a peer list) based on the locality criteria. As mentioned above the peer list may include information indicating that a particular peer is capable of providing a particular item of streaming media to other peers. The peer computer system in possession of the peer list may then monitor for any requests for streaming media (operation 308). The requests may be received by the communications module 240 either from a consumer that accesses the peer locally of from other peer computer systems connected to the network.

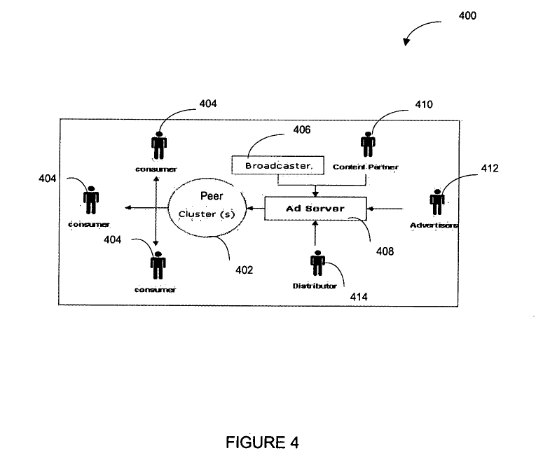

When the communications module 240 receives such request at operation 310, the peer lit may be utilized to process the request at operation 312. Specifically, in one example embodiment, if the request is received from a consumer that accesses the peer locally and the requested item of streaming media is not available locally, the peer selector 250 may determine a peer from the peer list that is capable of providing the requested item of streaming media and obtains the requested item. If the request for an item of streaming media is received from another peer from the peer list, the item may be provided to the requesting peer. A per-to-peer streaming platform, in one example embodiment, may be implemented in the context of a broadcast distribution system. An example of a broadcast distribution system may be described with reference to FIG. 4.

FIG. 4 is a block diagram illustrating a broadcast distribution system 400 with an advertisement server integrated into a peer to peer environment, in accordance with an example embodiment. The example broadcast distribution system 400 illustrated in FIG. 4 includes peer clusters 402, consumers 404, a broadcaster 406, an advertisement server 408, a content partner 410, advertisers 412, and distributors 414. The advertisement server 408 may utilize a rules engine to process a range of variables and to determine what advertisement to deliver to which targeted consumers at a given time.

In one example embodiment, the advertisement server 408 is configured to provide advertisement campaign services to advertisers to permit advertisers and their agents to build, query, modify and cancel their advertisement campaigns. The example advertisement server 408 includes a number of components or models, such as advertisement campaign management, advertisement management, advertiser account management, advertisement delivery management, and advertisement log tracking.

The broadcast distribution system 400, in one example embodiment, may utilize relationships between content partners, advertisers, a network of distributors, and an audience of consumers. Content partners are individuals or entities who enter into a digital distribution and possibly an advertisement insertion agreement with a broadcast management system. Advertisers are individuals, entities, or agents who enter into an advertisement insertion contract with the broadcast management system. Distributors are individuals or entities who aggregate an audience and enter into a reseller, network affiliate, or distribution agreement with the broadcast management system. Consumers are individuals who register, download, and consume video via a client application, such as a media player.

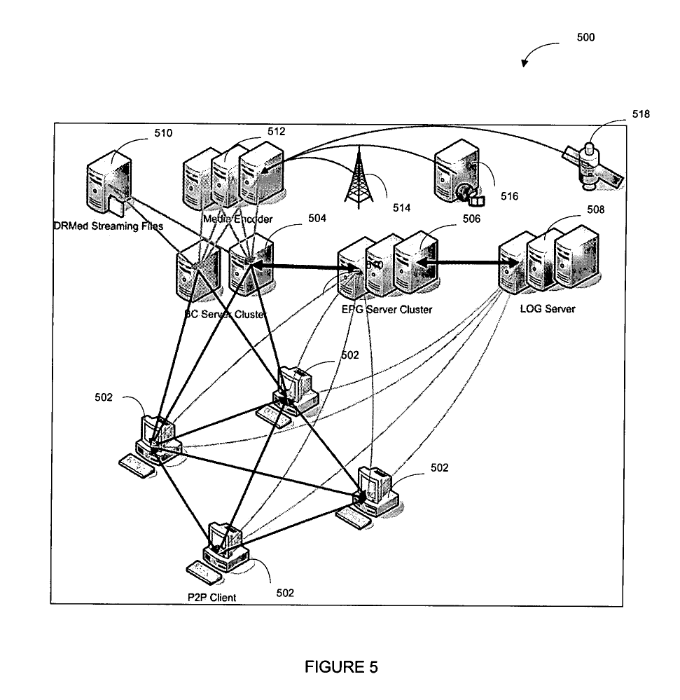

In one example embodiment, the broadcast distribution system 400 may be utilized with the system 200 illustrated in FIG. 2 to provide content via a peer-to-peer network. The broadcast distribution system 400 may be configured such that streams from multiple sources may be broadcast through a peer-to-peer streaming platform. An example peer-to-peer streaming platform is illustrated in FIG. 5, which is described further below.

A peer-to-peer streaming platform, in one example embodiment, may be configured to support television broadcasts, satellite broadcasts, as well as downloaded content. The data transfer rate may be adjustable or configurable on a peer-to-peer streaming platform. Programming may come from different sources, and may be encoded into a standard digital stream in order to be sent to peers. Program data may be captured in a streaming format with a proper data transfer rate. The streaming data transfer rate may be defined, in one example embodiment, by a digital video capture application and a media encoder during the video signal conversion process.

In one example embodiment, programs from multiple channels may be broadcast at the same time. A program guide may be pre-defined for each channel. A broadcast management system maintained within a peer-to-peer streaming platform may be configured to acquire program guides from third parties or define its own program guide, e.g., utilizing Extensible Markup Language (XML) format. These program guides may be stored, for example, on an entertainment program guide (EPG) server and may be accessed periodically by peer computer systems. The integration between the EPG server and the peer computer systems may be managed utilizing web services.

The usage patterns of the online audience may be reported to a log server provided with the peer-to-peer streaming platform. The usage patterns data may be utilized for displaying the number of concurrent users watching specific channels or programs at a given time. A peer-to-peer streaming platform may be configured to support multiple streaming formats, such as Windows® Media Video (wmv) or Windows® Media Audio (wma). In the peer-to-peer streaming platform, delivered programs may be protected by DRM.

Within an example streaming peer-to-peer platform, programs are defined to be delivered to a specific area (e.g., a particular geographic region) based on the location of peer computer systems. The programs available via the streaming peer-to-peer platform may be classified as free programs or as premium programs. Before a consumer is permitted to view a program, the consumer may have to be authenticated to the streaming peer-to-peer platform. When a consumer accesses premium programs, payment verification is established before the consumer may view the associated content file. In one example embodiment, all audience viewing data is logged for further use, such as reporting purposes.

A peer-to-peer streaming client (e.g., a peer-to-peer media player) may display video advertisements or banner advertisements that are provided by the advertisement server 408, according to a predetermined criteria. The predetermined criteria may include consumer's demographic information, consumer's locality, the currently viewed channel or program, etc. A peer-to-peer streaming client may display a program guide for each channel and may be configured to support both English (single byte) and Chinese (multi-byte) characters.

FIG. 5 is a diagrammatic representation of an example architecture of a peer-to-peer streaming platform 500, in accordance with an example embodiment. The peer-to-peer streaming platform 500 may include peer computer systems 502, a cluster of broadcasting (BC) servers (sometimes referred to as a seeding servers) 504, a cluster of entertainment program guide (EPG) servers 506, a log server 508, a DRM server 510, and a media encoder 512.

As shown in FIG. 5, streaming media may be introduced from different sources. Programming could come from TV stations 514, satellites 518, and streaming servers 516. The programs obtained from the above sources may be encoded for streaming data transfer rate, e.g., at the media encoder 512 and further encrypted using DRM, e.g., at the DRM server 510. A program source may be pulled by the broadcasting server directly from the DRM server 510.

The BC server cluster 504, in one example embodiment, is responsible for pulling streams from different sources, e.g., form the media encoder 512 and from the EPG server cluster 506. When the BC server cluster 504 obtains a stream, the BC server cluster 504 may divide the stream into peer-to-peer packets and encrypt the peer-to-peer packets encapsulated into, e.g., Transmission Control Protocol (TCP) or User Datagram Protocol (UDP). The BC server cluster 504 may then distribute these packets to one or more of the peer computer systems 502 as seeding source. In parallel, it also sends channel or program information to the peer computer systems. The channel or program guides, in one example embodiment, are received from the EPG server cluster 506.

The EPG server cluster 506, in the example embodiment, is responsible for collecting and maintaining channel and program information in real time. The channel and program information may include the streaming data transfer rates for each channel, information regarding the currently online peer computer systems, average playing smoothness, and information regarding channel subscription service. The channel and program information may also include channel or program guide information that is designated to be distributed to peer computer systems. The EPG server cluster 506, in one example embodiment, handles channel or program requests from the BC server cluster 504 and facilitates the creation of new channels for the peer-to-peer streaming network.

The log server 508, in the example embodiment, is responsible for collecting peer computer system access information for each channel and consumer activities. Each of the peer computer systems 502, in the example embodiment, may acquire streams from other peer computer systems and serve the acquired streams to other peer computer systems. Thus, as mentioned above with reference to FIG. 1, the peer computer system may act as both a client and server at the same time within a peer-to-peer network environment. After acquiring streaming packets from another peer computer system, the peer computer system decrypts, reassembles and buffers the stream. In order to achieve a smooth playback, in one example embodiment, a buffering algorithm may be provided for adaptive buffering time. The peer computer systems 502 may operate in different modes, such as downloading, progressive downloading, VOD, and live broadcasting. Because an audience member could download a program for offline viewing, a monitor application may be provided with a peer computer system 502 to accommodate audience viewing activities and to facilitate the transfer of sampling data to the log server 508.

As discussed above, with reference to FIG. 4, a broadcast distribution system may include an advertisement server integrated with a peer-to-peer network to provide targeted advertisements to consumers. The advertisement server 408 illustrated in FIG. 4, in an example embodiment, provides advertisement campaign services to advertisers. The advertisement server 408 may provide a self-service platform that can be utilized by both advertisers and content providers. Within such self-service platform, advertisers and their agents may create, search, modify and cancel their advertisement campaigns. Advertisers may also access portal audience activity reports based on the viewed channels and programs in order facilitate refining of their advertisement campaigns and to summarize their campaign execution report after advertisement delivery.

The advertisement server 408 may be configured to cooperate with a log server (such as the log server 508 of FIG. 5). A log server, in one example embodiment, samples viewing behavior data from the audience that consumes the delivered advertisement and media programs. Gathering audience viewing statistics for specific media or program may allow content providers who have access to the advertisement server 408 to focus the marketing for their programs based on the preferences manifested by the audience.

For the live broadcasting mode, the advertisement server 408 may deliver video or banner advertisements to peer computer systems based on pre-defined clusters of peer computer systems or audience based on localities. In this mode, the program streaming may be live but at the same time controllable by BC server distribution, and a targeted video advertisement stream may be injected through BC server control and tagged with audience cluster information to broadcast into peer-to-peer networks. In one example embodiment, when a peer computer system attempts to locate a tagged video advertisement stream within the peer-to-peer network, the peer computer system may begin to acquire the video advertisement stream if the audience cluster information tag is matched on both sides.

The following is a high-level algorithm, according to an example embodiment, that implements a technique for delivering advertisements based on pre-defined clusters.
1) When an audience member logins into the broadcast management system central authentication service (CAS) server, the audience member is labeled with a cluster value tag (e.g., A or B). The choice of a value tag may be based upon demographic information or by pre-defined user clusters in broadcast management system audience database.
2) As additional peer computer systems login into the broadcast management system CAS server, they are labeled with different tags (e.g., A, B, C, etc.). An audience with the same tag may be viewed as an audience cluster, which is identified as such by the advertisement server 408. The advertisement server 408 delivers advertisement campaigns targeting the identified audience cluster.
3) Different broadcasting servers simultaneously inject different video advertisement streaming into the peer-to-peer network, (e.g., represented by an advertisement stream 1 and an advertisement stream 2). The advertisement stream 1 is labeled with tag A because it is targeted to audience cluster A, the advertisement stream 2 is labeled with tag B because it is targeted to audience cluster B.
4) When an advertisement stream encapsulated in a peer-to-peer packet with tag A is sent to the audience cluster with tag A, the advertisement stream is buffered for reassembly. However, if an advertisement stream encapsulated in peer-to-peer packet with tag B is sent to an audience cluster with tag A, the advertisement stream is dropped and not delivered to the audience cluster having an unmatched tag.
5) Thus, the audience cluster A only acquires advertisement streams peer-to-peer packets tagged with tag A for media player display.

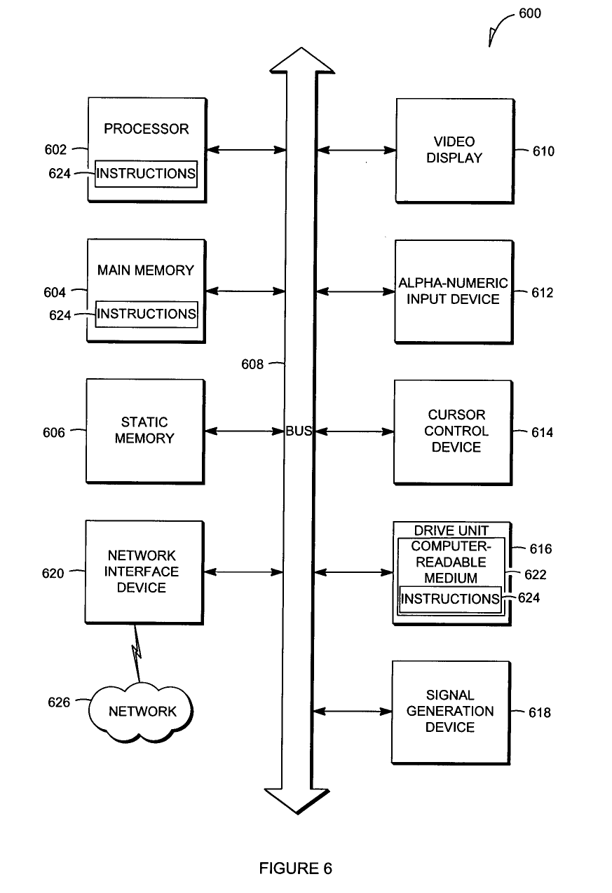

FIG. 6 shows a diagrammatic representation of a machine in the example form of a computer system 600 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a combination television (TV)/computer device, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alpha-numeric input device 612 (e.g., a keyboard), a user interface (UI) navigation device 614 (e.g., a cursor control device), a disk drive unit 616, a signal generation device 618 (e.g., a speaker) and a network interface device 620.

The disk drive unit 616 includes a machine-readable medium 622 on which is stored one or more sets of instructions and data structures (e.g., software 624) embodying or utilized by any one or more of the methodologies or functions described herein. The software 624 may also reside, completely or at least partially, within the main memory 604 and/or within the processor 602 during execution thereof by the computer system 600, the main memory 604 and the processor 602 also constituting machine-readable media.

The software 624 may further be transmitted or received over a network 626 via the network interface device 620 utilizing any one of a number of well-known transfer protocols (e.g., Hyper Text Transfer Protocol (HTTP)).

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of embodiments of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware.

Thus, a peer-to-peer broadcast management system have been described. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

1. A system comprising:
a peer detector to determine one or more peer computer systems associated with a predetermined locality;
a peer list generator to generate a peer list of the determined peer computer systems;
a communications module to receive a request for content; and
a peer selector to process the request for content utilizing the peer list.

2. The system of claim 1, wherein:
the communications module is to receive a request the request for content from a local media player application; and
the peer selector is to:
determine that the content is not available locally, and
obtain the content from a peer computer system from the peer list.

3. The system of claim 2, wherein the communications module is to provide the content to the local media player application.

4. The system of claim 1, wherein:
the communications module is to receive the request for content from a peer computer system; and
the peer selector is to:
determine that the content is available locally,
determine an entry in the peer list associated with the peer computer system, and
provide the content to the peer computer system.

5. The system of claim 1, wherein the locality is associated an IP address block.

6. The system of claim 1, wherein the locality is associated with an ISP.

7. The system of claim 1, wherein the locality is associated with a ZIP code.

8. The system of claim 1, wherein the requested content is a broadcast program.

9. The system of claim 1, wherein the requested content is a video on demand (VOD) program.

10. A method comprising:
in a network environment, determining one or more peer computer systems associated with a predetermined locality;
generating a peer list of the determined peer computer systems;
receiving a request for content; and
utilizing the peer list to process the request for content.

11. The method of claim 10, wherein:
the receiving of the request for content comprises receiving the request for content from a local media player application; and
the utilizing of the peer list to process the request for content comprises:
determining that the content is not available locally, and
obtaining the content from a peer computer system from the peer list.

12. The method of claim 11, further providing the content to the local media player application.

13. The method of claim 10, wherein:
the receiving of the request for content comprises receiving the request for content from a peer computer system; and
the utilizing of the peer list to process the request for content comprises:
determining that the content is available locally,
determining an entry in the peer list associated with the peer computer system, and
providing the content to the peer computer system.

14. The method of claim 10, wherein the locality is associated an IP address block.

15. The method of claim 10, wherein the locality is associated with an ISP.

16. The method of claim 10, wherein the locality is associated with a ZIP code.

17. The method of claim 10, wherein the requested content is a broadcast program.

18. The method of claim 10, wherein the requested content is video on demand (VOD) program.

19. A machine-readable medium having instruction data to cause a machine to:
determine one or more peer computer systems associated with a predetermined locality;
generate a peer list of the determined peer computer systems;
receive a request for content; and
process the request for content utilizing the peer list. 20. A system comprising:
means for determining one or more peer computer systems associated with a predetermined locality;
means for generating a peer list of the determined peer computer systems;
means for receiving a request for content; and
means for utilizing the peer list to process the request for content.
